(19) United States
(12) Patent Application Publication
(10) Pub. No.: US 2014/0269579 A1
(43) Pub. Date: Sep. 18, 2014

(54) METHOD AND APPARATUS FOR CONTROLLING TRANSMISSION POWER OF A PRACH

(71) Applicant: FUJITSU LIMITED, Kawasaki-shi (JP)

(72) Inventors: Yueqiao XU, Beijing (CN); Haibo XU, Beijing (CN); Hua ZHOU, Beijing (CN)

(73) Assignee: FUJITSU LIMITED, Kawasaki-shi (JP)

(21) Appl. No.: 14/289,176

(22) Filed: May 28, 2014

Related U.S. Application Data
(63) Continuation of application No. PCT/CN2011/083100, filed on Nov. 29, 2011.

(51) Int. Cl. H04W 52/14; H04W 52/24

(52) U.S. Cl. CPC H04W 52/146; H04W 52/242
USPC 370/329

(57) ABSTRACT

Controlling transmission power of a PRACH and apparatus, including: receiving, by a source RP, relevant parameters of a target RP for receiving a PRACH transmitted by the target RP; transmitting, by the source RP, the relevant parameters of the target RP for receiving the PRACH to CoMP UE; transmitting, by the source RP, an index of a pathloss value between the CoMP UE and the target RP to the CoMP UE, so that the CoMP UE determines the transmission power of the PRACH according to target reception power in the relevant parameters of the target RP for receiving the PRACH and the pathloss value. The CoMP UE may transmit the PRACH to the target RP with correct transmission power, obtain TA value between the CoMP UE and the target RP, and establish uplink synchronization with the target RP, thereby accessing to the target RP.

### CROSS-REFERENCE TO RELATED APPLICATIONS

This is a continuation of International Application No. PCT/CN2011/083100, filed on Nov. 29, 2011, now pending, the contents of which are herein wholly incorporated by reference.

### TECHNICAL FIELD

The present invention relates to the field of communications, and in particular to a method and apparatus for controlling transmission power of a physical random access channel (PRACH) in a coordinated multi-point transmission/reception (CoMP) scenario.

### BACKGROUND ART

In an LTE-advanced (LTE-A) system, CoMP is brought into the LTE-A framework as one of key technologies. In a CoMP scenario, geographically neighboring transmission points transmit signals to a user in cooperation, and for a cell-edge user, signal quality may be improved particularly, and coverage may be expanded. In the process of standardization of 3GPP LTE-A, four scenarios are defined for uplink and downlink CoMP (UL/DL CoMP):

a) homogeneous network with intra-site CoMP;

b) homogeneous network with remote radio heads (RRHs) of high transmission power;

c) heterogeneous network scenario in which RRHs of low power are distributed in a coverage of a macro cell and having different cell ID; and

d) heterogeneous network scenario in which RRHs of low power are distributed in a coverage of a macro cell and having identical cell ID.

Wherein, two scenarios are defined for uplink CoMP: joint reception (JR) and single point reception. In the single point reception scenario, CoMP user equipment (UE) may be configured with semi-static or dynamic reception point variation. When a single reception point (RP, including an eNB or an RRH) changes, for example, when an uplink single reception point of CoMP UE in FIG. 1 changes from an eNB to an RRH1, the UE needs to establish uplink synchronization with a target reception point, i.e. the RRH1, so as to ensure that uplink signals of all the user equipment in the coverage of the RRH1 reach the RRH1 at the same time, so that there exists no interference between uplink signals of user equipment reaching the RRH1, and reception performance of the CoMP UE is ensured.

In the Implementation of the present invention, the inventors found that in order to establish uplink synchronization with a target reception point, for example, in FIG. 1, the CoMP UE needs to establish uplink synchronization with the RRH1, the UE needs to transmit an uplink signal with appropriate timing advance (TA). However, currently, in an uplink single point reception scenario of the CoMP, how to obtain a TA value is not defined. If what is defined in an LTE standard or an LTE-A standard is used that a TA value between UE and a target reception point is obtained by transmitting a PRACH, a problem exists in control of transmission power for transmitting the PRACH to the target reception point, and an expected effect cannot be produced.

It should be noted that the above description of the background art is merely provided for clear and complete explanation of the present invention and for easy understanding by those skilled in the art. And it should not be understood that the above technical solution is known to those skilled in the art as it is described in the background art of the present invention.

### SUMMARY OF THE INVENTION

An object of the embodiments of the present invention is to provide a method and apparatus for controlling transmission power of a PRACH in an uplink CoMP scenario when UE accesses to a target reception point, so as to ensure that the UE accesses to a target cell with correct transmission power.

According to one aspect of the embodiments of the present invention, there is provided a method for controlling transmission power of a physical random access channel (PRACH), including:

transmitting, by a source reception point (RP), relevant parameters of a target RP for receiving a PRACH to user equipment in a coordinated multipoint transmission system (CoMP UE); and
transmitting, by the source RP, an index of a pathloss value between the CoMP UE and the target RP to the CoMP UE, so that the CoMP UE determines the transmission power of the PRACH according to target reception power in the relevant parameters of the target RP for receiving the PRACH and the pathloss value.

According to another aspect of the embodiments of the present invention, there is provided a method for controlling transmission power of a PRACH, including:

acquiring, by CoMP UE from a source RP, relevant parameters of a target RP for receiving a PRACH;

determining, by the CoMP UE, a pathloss value between the CoMP UE and the target RP according to an index of the pathloss value transmitted by the source RP; and

determining, by the CoMP UE, transmission power of the PRACH according to target reception power in the relevant parameters of the target RP for receiving the PRACH and the pathloss value.

According to still another aspect of the embodiments of the present invention, there is provided an uplink synchronization method between CoMP UE and a target RP, including:

determining, by the CoMP UE, transmission power of a PRACH from the CoMP UE to the target RP;

transmitting the PRACH to the target RP by the CoMP UE according to the determined transmission power of the PRACH; and

performing uplink synchronization with the target RP by the CoMP UE according to timing advance (TA) fed back by the target RP.

According to still another aspect of the embodiments of the present invention, there is provided a base station in a CoMP transmission system, including:

a first transmitting unit configured to transmit relevant parameters of a target RP for receiving a PRACH to CoMP UE; and

a second transmitting unit configured to transmit an index of a pathloss value between the CoMP UE and the target RP to the CoMP UE, so that the CoMP UE determines transmission power of the PRACH according to target reception power in the relevant parameters of the target RP for receiving the PRACH and the pathloss value.

According to still another aspect of the embodiments of the present invention, there is provided UE in a CoMP transmission system (CoMP UE), including:

an acquiring unit configured to acquire, from a source RP, relevant parameters of a target RP for receiving a PRACH;

a first determining unit configured to determine a pathloss value between the CoMP UE and the target RP according to an index of the pathloss value transmitted by the source RP; and

a second determining unit configured to determine transmission power of the PRACH according to target reception power in the relevant parameters of the target RP for receiving the PRACH and the pathloss value.

According to still another aspect of the embodiments of the present invention, there is provided UE in a CoMP transmission system (CoMP UE), including:

a determining unit configured to determine transmission power of a PRACH from the CoMP UE to a target RP;

a transmitting unit configured to transmit the PRACH to the target RP according to the determined transmission power of the PRACH; and

a synchronizing unit configured to perform uplink synchronization with the target RP according to TA fed back by the target RP.

According to still another aspect of the embodiments of the present invention, there is provided a computer-readable program, wherein when the program is executed in a base station, the program enables a computer to carry out the method for controlling transmission power of a PRACH as described above in the base station.

According to still another aspect of the embodiments of the present invention, there is provided a storage medium in which a computer-readable program is stored, wherein the computer-readable program enables a computer to carry out the method for controlling transmission power of a PRACH as described above in a base station.

According to still another aspect of the embodiments of the present invention, there is provided a computer-readable program, wherein when the program is executed in UE, the program enables a computer to carry out the method for controlling transmission power of a PRACH or the uplink synchronization method between CoMP UE and a target RP as described above in the UE.

According to still another aspect of the embodiments of the present invention, there is provided a storage medium in which a computer-readable program is stored, wherein the computer-readable program enables a computer to carry out the method for controlling transmission power of a PRACH or the uplink synchronization method between CoMP UE and a target RP as described in UE.

The advantage of the embodiments of the present invention resides in that with the method and apparatus for controlling power for transmitting a PRACH, the CoMP UE may transmit the PRACH to the target reception point with correct transmission power, so as to obtain a TA value between the CoMP UE and the target reception point, and establish uplink synchronization with the target reception point, thereby accessing to a target cell.

With reference to the following description and drawings, the particular embodiments of the present invention are disclosed in detail, and the principle of the present invention and the manners of use are indicated. It should be understood that the scope of the embodiments of the present invention is not limited thereto. The embodiments of the present invention contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. To facilitate illustrating and describing some parts of the invention, corresponding portions of the drawings may be exaggerated or reduced in size. Elements and features depicted in one drawing or embodiment of the invention may be combined with elements and features depicted in one or more additional drawings or embodiments. Moreover, in the drawings, like reference numerals designate corresponding parts throughout the several views and may be used to designate like or similar parts in more than one embodiment. In the drawings:

FIG. 1 is a schematic diagram of variation of an uplink reception point of CoMP UE;

FIG. 2 is a flowchart of a method for controlling transmission power of a PRACH of an embodiment of the present invention;

FIG. 3 is a flowchart of a method for controlling transmission power of a PRACH of another embodiment of the present invention;

FIG. 4 is a flowchart of a uplink synchronization method between CoMP UE and a target reception point of an embodiment of the present invention;

FIG. 5 is a schematic diagram of the structure of a base station in a CoMP transmission system of an embodiment of the present invention;

FIG. 6 is a schematic diagram of the structure of user equipment in a CoMP transmission system of an embodiment of the present invention; and

FIG. 7 is a schematic diagram of the structure of user equipment in a CoMP transmission system of another embodiment of the present invention.

### DETAILED DESCRIPTION OF THE INVENTION

Foregoing and other features of the embodiments of the present invention will become apparent with reference to the drawings and the following description. These embodiments are illustrative only and are not intended to limit the present invention. For easy understanding of the principle and embodiments of the present invention by those skilled in the art, the embodiments of the present invention shall be described taking an uplink CoMP scenario in an LTE-A system as an example, in which UE is configured with a single point reception scenario of semi-static or dynamic reception point variation, and the UE transmits a PRACH to a target reception point to obtain a TA value so as to establish uplink synchronization with the target reception point. However, it should be appreciated that the embodiments of the present invention are not limited to the above scenario, and are also applicable to other scenarios related to transmission of a PRACH.

In the following description, unless otherwise specified, a user refers to CoMP UE, that is, user equipment in a CoMP transmission system, a source reception point and a target reception point refer to base stations serving for the user in the CoMP transmission system, and the base station here may be a macro base station (such as an eNB), and may also be a pico base station (such as an RRH).

In an existing LTE standard, in a method for obtaining TA to establish uplink synchronization, user equipment transmits a random access channel (RACH) preamble in a physical random access channel (PRACH). Furthermore, in a process of LTE-advanced standardization, when an uplink reception point of user equipment changes from a primary cell (Pcell) to a secondary cell (Scell) in a carrier aggregation (CA) scenario, it is also defined that the user equipment obtains a TA value between the user equipment and the Scell by transmitting a PRACH to the Scell, so as to establish uplink synchronization with the Scell. In an uplink CoMP single point reception scenario, if a similar method is employed, when a reception point changes, the CoMP UE transmit a PRACH to the target reception point, so as to obtain a TA value to establish new uplink synchronization with the target reception point, and according to LTE R10, an expression of uplink power control for transmitting a PRACH is:

P_{PRACH}=min{P_{CMAX,c}(i),PREAMBLE_RECEIVED_TARGET_POWER+PL_{c}}_[dbm]

where, P_{CMAX,c}(i) is maximum rated transmission power configured for the user equipment defined in TS36.101 for subframe i of the serving cell c, PL_{c} is a value of a pathloss from the user equipment to the serving cell c, and the parameter PREAMBLE_RECEIVED_TARGET_POWER is a broadcasted system message, denoting a target reception power value for transmitting a preamble, that is, anticipated reception power.

However, in an uplink CoMP single point reception scenario, if user equipment is configured with establishing new uplink synchronization with a target reception point by transmitting a

PRACH, and determining transmission power of the PRACH by using the above expression of uplink power control, there exists a problem in the original power control of PRACH in LTE R10. On the one hand, the parameter PREAMBLE_RECEIVED_TARGET_POWER in the above expression is a system message broadcasted by an eNB to all the user equipment in its coverage, denoting a value of power for receiving the PRACH transmitted by the user equipment, which is anticipated by an eNB cell. While when the reception point changes, the parameter should denote a value of power for receiving the PRACH of a target cell anticipated by user equipment to access; and it is obvious that these two values are different. And on the other hand, PL_{c} in the above expression should denote a value of pathloss between the user equipment and the target cell, which is used to compensate for a pathloss between the user equipment and the target reception point in uplink CoMP, but not a value of pathloss between the user equipment and the eNB.

Based on the above, the method and apparatus for controlling transmission power of a PRACH of the embodiments of the present invention are proposed.

### Embodiment 1

An embodiment of the present invention provides a method for controlling transmission power of a PRACH. FIG. 2 is a flowchart of the method. Referring to FIG. 2, the method includes:

step 201: transmitting, by a source reception point, relevant parameters of a target reception point for receiving a PRACH to user equipment in a coordinated multipoint transmission system (CoMP UE);

in step 201, signaling exchange may be performed between the target reception point and the source reception point via a backhaul, such as an optical fiber, and a set of PRACH-related parameters, such as target reception power (PREAMBLE_RECEIVED_TARGET_POWER) for receiving a PRACH, a power ramping step, and a maximum number of retransmissions for transmitting a PRACH, etc., are informed to the source reception point, and the source reception point transmits the relevant parameters of the target reception point for receiving the PRACH to the CoMP UE;

in an embodiment of step 201, the source reception point may inform the relevant parameters of the target reception point for receiving the PRACH to the CoMP UE via UE-specific radio resource control (RRC) signaling; however, this embodiment is not limited thereto, therefore, the CoMP UE may obtain a value of the PREAMBLE_RECEIVED_TARGET_POWER related to the target reception point and a corresponding parameter for transmitting a PRACH via the RRC signaling transmitted by the source reception point;

with step 201, the CoMP UE may obtain target reception power of the target reception point for receiving a PRACH;

step 202: transmitting, by the source reception point, an index of a pathloss value between the CoMP UE and the target reception point to the CoMP UE, so that the CoMP UE determines the transmission power of the PRACH according to target reception power in the relevant parameters of the target reception point for receiving the PRACH and the pathloss value;

in step 202, an eNB configures the CoMP UE with multiple channel state information-reference signal (CSI-RS) resources, each CSI-RS resource being associated with a possible uplink reception point (an RRH or an eNB), so as to be used by the CoMP UE for measuring a pathloss value between the CoMP UE and each possible uplink reception point; while configuring the CoMP UE with the multiple CSI-RS resources, the eNB also informs the CoMP UE of an index value to which each CSI-RS resource corresponds, that is, creating a resource index table, in which both parties of the eNB and the CoMP UE are known; each index value is associated with a unique CSI-RS resource, so that a pathloss value of uplink reception point to which the CSI-RS resource corresponds can be obtained; in this embodiment, in the power control of the UE in transmitting the PRACH, a pathloss value corresponding to the target reception point (an RRH) needs to be employed, that is, it is only needed that the eNB transmits an index value of a CSI-RS resource corresponding to the RRH (i.e. an index of the pathloss value) to the UE;

in step 202, the source reception point may transmit the index of the pathloss value between the CoMP UE and the target reception point to the CoMP UE via downlink control information (DCI) carrying a physical downlink control channel (PDCCH) order, such as a DCI format 1A, and may also transmit the index of the pathloss value between the CoMP UE and the target reception point to the CoMP UE via UE-specific radio resource control signaling.

If the index of the pathloss value between the CoMP UE and the target reception point is transmitted to the CoMP UE via the downlink control information (DCI format 1A) carrying a physical downlink control channel order (a PDCCH order), there may be following two modes of implementation.

In one mode of implementation, the source reception point triggers, via the PDCCH order, the CoMP UE to transmit the PRACH, in the DCI format 1A where the PDCCH order triggers the CoMP UE to transmit the PRACH, 3 bits of signaling used for a carrier indicator in carrier aggregation (CA), i.e. carrier indicator-0 or 3 bits, is reused to denote an index of a pathloss value. For example, an index of a pathloss value from the CoMP UE to the target reception point may be indicated via a CoMP index indicator.

In this mode of implementation, in order to avoid the effect of reuse of the bit signaling used for the carrier indicator in the CA on the carrier indicator, whether the content indicated by the above 3 bits of signaling is a carrier indicator in the carrier aggregation or a CoMP index indicator in CoMP may also be denoted via 1 bit of information “flag” in the DCI format 1A. For example, it is denoted by “flag:0” that the above 3 bits of signaling is used for the carrier indicator, that is, it is denoted that the above 3 bits of signaling is a carrier indicator in the carrier aggregation; and it is denoted by “flag:1” that the above 3 bits of signaling is used for indicating an index of a pathloss value, that is, it is denoted that the above 3 bits of signaling is a CoMP index indicator in CoMP.

In another mode of implementation, the source reception point also triggers the CoMP UE to transmit the PRACH via the PDCCH order, in the DCI format 1A carrying the PDCCH order, a remaining redundancy bit is used to define a parameter “CoMP index indicator”, which is used to indicate an index of a pathloss value PL between the CoMP UE and the target reception point. For example, 3 bits of redundancy bits are used to define the parameter “CoMP index indicator”.

If the index of the pathloss value between the CoMP UE and the target reception point is transmitted to the CoMP UE via UE-specific radio resource control signaling, the source reception point, such as an eNB, may indicate the index of the pathloss value PL used in transmitting the PRACH by the CoMP UE by transmitting a UE-specific RRC parameter.

With the above three modes of implementation, the source reception point may transmit the index of the pathloss value between the CoMP UE and the target reception point to the CoMP UE.

In this embodiment, the source reception point transmits the relevant parameters of the target reception point for receiving the PRACH and the index of the pathloss value between the CoMP UE and the target reception point to the CoMP UE, and the CoMP UE may determine transmission power of the PRACH by using the above power control expression according to target reception power in the above relevant parameters and a pathloss value to which the above index corresponds, so as to transmit the PRACH to the target reception point with the determined transmission power of the PRACH. Wherein, the CoMP UE may further adjust the transmission power for transmitting the PRACH according to such parameters in the above relevant parameters as a power ramping step, and a maximum number of retransmission, etc.

After receiving the PRACH transmitted by the CoMP UE, the target reception point may feed a corresponding TA value back to the CoMP UE, and the CoMP UE may determine a TA value at which data are transmitted to the target reception point. Therefore, the CoMP UE may establish uplink synchronization with the target reception point, and access to a cell covered by the target reception point.

With the method of the embodiment of the present invention, the CoMP UE may transmit a PRACH to the target reception point with correct transmission power, obtain a TA value between the CoMP UE and the target reception point, and establish uplink synchronization with the target reception point, thereby accessing to a target cell.

In Embodiment 1, the method for controlling transmission power of a PRACH is described at the source reception point side. And the method for controlling transmission power of a PRACH shall be described at the UE side in Embodiment 2. Wherein, contents identical to those in Embodiment 1 shall be incorporated in Embodiment 2.

### Embodiment 2

An embodiment of the present invention further provides a method for controlling transmission power of a PRACH. FIG. 3 is a flowchart of the method. Referring to FIG. 3, the method includes:

step 301: acquiring, by CoMP UE from a source reception point, relevant parameters of a target reception point for receiving a PRACH;

wherein, step 301 corresponds to step 201 of Embodiment 1, and after exchanging the relevant parameters of the target reception point for receiving the PRACH with the target reception point, the source reception point may inform the CoMP UE of the relevant parameters of the target reception point for receiving the PRACH via UE-specific RRC signaling, which shall not be described herein any further;

step 302: determining, by the CoMP UE, a pathloss value between the CoMP UE and the target reception point according to an index of the pathloss value transmitted by the source reception point;

wherein, step 302 corresponds to step 202 of Embodiment 1, and the source reception point may indicate the index of the pathloss value between the CoMP UE and the target reception point via the DCI format 1A carrying the PDCCH order (by reusing signaling used for a carrier indicator in CA or by using a remaining redundancy bit), and may also indicate the index of the pathloss value between the CoMP UE and the target reception point via a UE-specific RRC parameter, which shall not be described herein any further; with the index of the pathloss value, the CoMP UE may determine the pathloss value between the CoMP UE and the target reception point;

step 303: determining, by the CoMP UE, transmission power of the PRACH according to target reception power in the relevant parameters of the target reception point for receiving the PRACH and the pathloss value;

wherein, after obtaining the target transmission power of the target reception point for receiving the PRACH and the pathloss value from the CoMP UE to the target reception point respectively in step 301 and 302, the CoMP UE may determine the transmission power of the PRACH by using the two parameters; for example, by using the above expression of power control, the parameter obtained in step 301 is taken as “PREAMBLE_RECEIVED_TARGET_POWER” in the above expression of power control, and the parameter obtained in step 302 is taken as “PL_{c}” in the above expression of power control. Furthermore, the CoMP UE may adjust the transmission power or transmission of the PRACH by using other parameters in the relevant parameters of the target reception point for receiving the PRACH.

With the method of the embodiment of the present invention, the CoMP UE may transmit a PRACH to the target reception point with correct transmission power, obtain a TA value between the CoMP UE and the target reception point, and establish uplink synchronization with the target reception point, thereby accessing to a target cell.

### Embodiment 3

An embodiment of the present invention further provides an uplink synchronization method between CoMP UE and a target reception point. FIG. 4 is a flowchart of the method. Referring to FIG. 4, the method includes:

step 401: determining, by the CoMP UE, transmission power of a PRACH from the CoMP UE to the target reception point;

wherein, step 401 may be carried out by using the method of Embodiment 2, the contents of which are incorporated herein, and shall not be described herein any further;

step 402: transmitting the PRACH to the target reception point by the CoMP UE according to the determined transmission power of the PRACH; and

step 403: performing uplink synchronization with the target reception point by the CoMP UE according to timing advance (TA) fed back by the target reception point;

wherein, after obtaining the TA from the CoMP UE to the target reception point by transmitting the PRACH to the target reception point, the CoMP UE may transmit data to the target reception point with this TA value, thereby establishing synchronization with the target reception point.

With the method of the embodiment of the present invention, the CoMP UE may transmit a PRACH to the target reception point with correct transmission power, obtain a TA value between the CoMP UE and the target reception point, and establish uplink synchronization with the target reception point, thereby accessing to a target cell.

An embodiment of the present invention further provides a base station, as described in Embodiment 4 below. As the principle of the base station for solving problem is similar to that of the method for controlling transmission power of a PRACH in Embodiment 1, the implementation of the method may be referred to for the implementation of the base station, and the repeated parts shall not be described any further.

### Embodiment 4

An embodiment of the present invention further provides a base station in a CoMP transmission system. FIG. 5 is a schematic diagram of the structure of the base station. Referring to FIG. 5, the base station includes:

a first transmitting unit 501 configured to transmit relevant parameters of a target reception point for receiving a PRACH to CoMP UE; and

a second transmitting unit 502 configured to transmit an index of a pathloss value between the CoMP UE and the target reception point to the CoMP UE, so that the CoMP UE determines transmission power of the PRACH according to target reception power in the relevant parameters of the target reception point for receiving the PRACH and the pathloss value.

In an embodiment, the base station further includes:

an exchanging unit 503 configured to perform signaling exchange with the target reception point, so as to obtain the relevant parameters of the target reception point for receiving the PRACH; wherein the relevant parameters include target reception power, a power ramping step, and a maximum number of retransmission.

In an embodiment, the first transmitting unit 501 is configured to transmit relevant parameters of the target reception point for receiving the PRACH to the CoMP UE via UE-specific radio resource control signaling.

In an embodiment, the second transmitting unit 502 is configured to transmit the index of the pathloss value between the CoMP UE and the target reception point to the CoMP UE via DCI format 1A carrying a PDCCH order, or transmit the index of the pathloss value between the CoMP UE and the target reception point to the CoMP UE via UE-specific radio resource control signaling.

In a mode of implementation of this embodiment, the second transmitting unit 502 indicates the index of the pathloss value by using a signaling in the DCI format 1A used for a carrier indicator, and differentiates a content indicated by the signaling with 1 bit information in the DCI format 1A, so as to transmit the index of the pathloss value to the CoMP UE.

In another mode of implementation of this embodiment, the second transmitting unit 502 indicates the index of the pathloss value by using a redundant bit in the DCI format 1A, so as to transmit the index of the pathloss value to the CoMP UE.

In this embodiment, the base station may be a macro base station in a CoMP transmission system, and may also be a pico base station in the CoMP transmission system. And all reception points taken as uplink single point reception of CoMP UE are covered by the protection scope of the present invention.

With the base station of the embodiment of the present invention, the CoMP UE may transmit a PRACH to the target reception point with correct transmission power, obtain a TA value between the CoMP UE and the target reception point, and establish uplink synchronization with the target reception point, thereby accessing to a target cell.

An embodiment of the present invention further provides user equipment, as described in Embodiment 5 below. As the principle of the user equipment for solving problem is similar to that of the method for controlling transmission power of a PRACH in Embodiment 2, the implementation of the method may be referred to for the implementation of the user equipment, and the repeated parts shall not be described any further.

### Embodiment 5

An embodiment of the present invention further provides user equipment (UE) in a CoMP transmission system (CoMP UE). FIG. 6 is a schematic diagram of the structure of the UE. Referring to FIG. 6, the UE includes:

an acquiring unit 601 configured to acquire, from a source reception point, relevant parameters of a target reception point for receiving a PRACH;

wherein, the relevant parameters of the target reception point for receiving the PRACH include target reception power of the target reception point for receiving the PRACH, a power ramping step, and a maximum number of retransmission, etc.;

a first determining unit 602 configured to determine a pathloss value between the CoMP UE and the target reception point according to an index of the pathloss value transmitted by the source reception point; and

a second determining unit 603 configured to determine transmission power of the PRACH according to target reception power in the relevant parameters of the target reception point for receiving the PRACH and the pathloss value;

wherein, after obtaining the target transmission power of the target reception point for receiving the PRACH and the pathloss value from the CoMP UE to the target reception point respectively by the acquiring unit 601 and the first determining unit 602, the UE of this embodiment may determine the transmission power of the PRACH by the second determining unit 603 by using the two parameters; for example, by using the above expression of power control, the parameter obtained by the acquiring unit 601 is taken as “PREAMBLE_RECEIVED_TARGET_POWER” in the above expression of power control, and the parameter obtained by the first determining unit 602 is taken as “PL_{c}” in the above expression of power control. Furthermore, the UE may adjust the transmission power or transmission of the PRACH by using other parameters in the relevant parameters of the target reception point for receiving the PRACH.

With the UE of the embodiment of the present invention, a PRACH may be transmitted to the target reception point with correct transmission power, a TA value between the UE and the target reception point may be obtained, and uplink synchronization with the target reception point may be established, thereby accessing to a target cell.

An embodiment of the present invention further provides user equipment, as described in Embodiment 6 below. As the principle of the user equipment for solving problem is similar to that of the uplink synchronization method between CoMP UE and a target reception point in Embodiment 3, the implementation of the method in Embodiment 3 may be referred to for the implementation of the user equipment, and the repeated parts shall not be described any further.

### Embodiment 6

An embodiment of the present invention further provides user equipment (UE) in a CoMP transmission system (CoMP UE). FIG. 7 is a schematic diagram of the structure of the UE. Referring to FIG. 7, the UE includes:

a determining unit 701 configured to determine transmission power of a PRACH from the CoMP UE to a target reception point;

a transmitting unit 702 configured to transmit the PRACH to the target reception point according to the determined transmission power of the PRACH; and

a synchronizing unit 703 configured to perform uplink synchronization with the target reception point according to TA fed back by the target reception point.

In an embodiment, the determining unit 701 includes:

an acquiring module 7011 configured to acquire, from a source reception point, relevant parameters of the target reception point for receiving the PRACH;

a first determining module 7012 configured to determine a pathloss value between the CoMP UE and the target reception point according to an index of the pathloss value transmitted by the source reception point; and

a second determining module 7013 configured to determine transmission power of the PRACH according to target reception power in the relevant parameters of the target reception point for receiving the PRACH and the pathloss value.

In particular, the functions of the components of the determining unit 701 may be carried out by the components of the UE of Embodiment 5, which shall not be described herein any further.

With the UE of the embodiment of the present invention, a PRACH may be transmitted to the target reception point with correct transmission power, a TA value between the UE and the target reception point may be obtained, and uplink synchronization with the target reception point may be established, thereby accessing to a target cell.

An embodiment of the present invention further provides a computer-readable program, wherein when the program is executed in a base station, the program enables a computer to carry out the method for controlling transmission power of a PRACH as described in Embodiment 1 in the base station.

An embodiment of the present invention further provides a storage medium in which a computer-readable program is stored, wherein the computer-readable program enables a computer to carry out the method for controlling transmission power of a PRACH as described in Embodiment 1 in a base station.

An embodiment of the present invention further provides a computer-readable program, wherein when the program is executed in UE, the program enables a computer to carry out the method for controlling transmission power of a PRACH as described in Embodiment 2 or the uplink synchronization method between CoMP UE and a target reception point as described in Embodiment 3 in the UE.

An embodiment of the present invention further provides a storage medium in which a computer-readable program is stored, wherein the computer-readable program enables a computer to carry out the method for controlling transmission power of a PRACH as described in Embodiment 2 or the uplink synchronization method between CoMP UE and a target reception point as described in Embodiment 3 in UE.

The above apparatuses and methods of the present invention may be implemented by hardware, or by hardware in combination with software. The present invention relates to such a computer-readable program that when the program is executed by a logic device, the logic device is enabled to carry out the apparatus or components as described above, or to carry out the methods or steps as described above. The present invention also relates to a storage medium for storing the above program, such as a hard disk, a floppy disk, a CD, a DVD, and a flash memory, etc.

The present invention is described above with reference to particular embodiments. However, it should be understood by those skilled in the art that such a description is illustrative only, and not intended to limit the protection scope of the present invention. Various variants and modifications may be made by those skilled in the art according to the spirits and principle of the present invention, and such variants and modifications fall within the scope of the present invention.

What is claimed is:

1. A base station in a CoMP transmission system, comprising:
a first transmitting unit configured to transmit relevant parameters of a target reception point (RP) for receiving a physical random access channel (PRACH) to user equipment in a coordinated multipoint transmission system (CoMP UE); and
a second transmitting unit configured to transmit an index of a pathloss value between the CoMP UE and the target RP to the CoMP UE, so that the CoMP UE determines transmission power of the PRACH according to target reception power in the relevant parameters of the target RP for receiving the PRACH and the pathloss value.

2. The base station according to claim 1, wherein the base station further comprises:
an exchanging unit configured to perform signaling exchange with the target RP, so as to obtain the relevant parameters of the target RP for receiving the PRACH;
wherein the relevant parameters comprise target reception power, a power ramping step, and a maximum number of retransmission.

3. The base station according to claim 1, wherein the first transmitting unit is configured to transmit the relevant parameters of the target RP for receiving the PRACH to the CoMP UE via UE-specific radio resource control (RRC) signaling.

4. The base station according to claim 1, wherein the second transmitting unit is configured to
transmit the index of the pathloss value between the CoMP UE and the target RP to the CoMP UE via downlink control information (DCI) format 1A carrying a physical downlink control channel (PDCCH) order; or
transmit the index of the pathloss value between the CoMP UE and the target RP to the CoMP UE via UE-specific RRC signaling.

5. The base station according to claim 4, wherein when the second transmitting unit transmits the index of the pathloss value between the CoMP UE and the target RP to the CoMP UE via the DCI format 1A carrying the PDCCH order, the second transmitting unit is configured to
indicate the index of the pathloss value by using a signaling in the DCI format 1A used for a carrier indicator and differentiate a content indicated by the signaling with 1 bit information in the DCI format 1A; or
indicate the index of the pathloss value by using a redundant bit in the DCI format 1A.

6. UE in a CoMP transmission system (CoMP UE), comprising:
an acquiring unit configured to acquire, from a source RP, relevant parameters of a target RP for receiving a PRACH;
a first determining unit configured to determine a pathloss value between the CoMP UE and the target RP according to an index of the pathloss value transmitted by the source RP; and
a second determining unit configured to determine transmission power of the PRACH according to target reception power in the relevant parameters of the target RP for receiving the PRACH and the pathloss value.

7. UE in a CoMP transmission system (CoMP UE), comprising:
a determining unit configured to determine transmission power of a PRACH from the CoMP UE to a target RP;
a transmitting unit configured to transmit the PRACH to the target RP according to the determined transmission power of the PRACH; and
a synchronizing unit configured to perform uplink synchronization with the target RP according to timing advance (TA)fed back by the target RP.

8. The UE according to claim 7, wherein the determining unit comprises:
an acquiring module configured to acquire, from a source RP, relevant parameters of the target RP for receiving the PRACH;
a first determining module configured to determine a pathloss value between the CoMP UE and the target RP according to an index of the pathloss value transmitted by the source RP; and
a second determining module configured to determine transmission power of the PRACH according to target reception power in the relevant parameters of the target RP for receiving the PRACH and the pathloss value.
